(19) United States
(12) Patent Application Publication
(10) Pub. No.: US 2015/0206223 A1
(43) Pub. Date: Jul. 23, 2015

(54) METHOD AND APPARATUS FOR RECOMMENDING A SELECTION BETWEEN A RESELLER AND A MULTI-SIDED PLATFORM

(71) Applicant: Xerox Corporation, Norwalk, CT (US)

(72) Inventors: Yu-An SUN, Webster, NY (US); Ming YIN, Cambridge, MA (US)

(73) Assignee: Xerox Corporation, Norwalk, CT (US)

(21) Appl. No.: 14/161,393

(22) Filed: Jan. 22, 2014

(51) Int. Cl. G06Q 30/06

(52) U.S. Cl. CPC G06Q 30/0631; G06Q 30/0613

(57) ABSTRACT

A method, non-transitory computer readable medium, and apparatus for recommending a selection between a reseller and a multi-sided platform (MSP) are disclosed. For example, the method defines all scenarios for a service provider, a first intermediary, a second intermediary and a customer, wherein the first intermediary and the second intermediary are each the reseller or the MSP, calculates a pay-off for the service provider, the first intermediary, the second intermediary and the customer for each one of the all scenarios, determines a scenario from the all scenarios that provides a maximum pay-off and recommends the selection between the reseller and the MSP based upon the scenario that provides the maximum pay-off.

The present disclosure relates generally to analyzing business models for marketplaces serving as intermediaries between buyers and sellers, and, more particularly, to a method and an apparatus for recommending a selection between a reseller and a multi-sided platform.

### BACKGROUND

For each newly launched marketplace that serves as an intermediary between buyers and sellers, the newly launched marketplace must decide which business model to adopt to make profits. Typically, the business model is chosen based upon a manual analysis and decision. The manual analysis may not analyze all of the possible variables that may affect the outcome of profits and all of the possible scenarios between all of the parties. The manual decision may also make a decision without having all of the relevant information to guide selection of a business model. Thus, business models are often adopted based upon an inaccurate or inefficient method.

### SUMMARY

According to aspects illustrated herein, there are provided a method, a non-transitory computer readable medium, and an apparatus for recommending a selection between a reseller and a multi-sided platform (MSP). One disclosed feature of the embodiments is a method that defines all scenarios for a service provider, a first intermediary, a second intermediary and a customer, wherein the first intermediary and the second intermediary are each the reseller or the MSP, calculates a pay-off for the service provider, the first intermediary, the second intermediary and the customer for each one of the all scenarios, determines a scenario from the all scenarios that provides a maximum pay-off and recommends the selection between the reseller and the MSP based upon the scenario that provides the maximum pay-off.

Another disclosed feature of the embodiments is a non-transitory computer-readable medium storing a plurality of instructions, the plurality of instructions including instructions which, when executed by a processor, cause the processor to perform an operation that defines all scenarios for a service provider, a first intermediary, a second intermediary and a customer, wherein the first intermediary and the second intermediary are each the reseller or the MSP, calculates a pay-off for the service provider, the first intermediary, the second intermediary and the customer for each one of the all scenarios, determines a scenario from the all scenarios that provides a maximum pay-off and recommends the selection between the reseller and the MSP based upon the scenario that provides the maximum pay-off.

Another disclosed feature of the embodiments is an apparatus comprising a processor and a computer readable medium storing a plurality of instructions which, when executed by the processor, cause the processor to perform an operation that defines all scenarios for a service provider, a first intermediary, a second intermediary and a customer, wherein the first intermediary and the second intermediary are each the reseller or the MSP, calculates a pay-off for the service provider, the first intermediary, the second intermediary and the customer for each one of the all scenarios, determines a scenario from the all scenarios that provides a maximum pay-off and recommends the selection between the reseller and the MSP based upon the scenario that provides the maximum pay-off.

### BRIEF DESCRIPTION OF THE DRAWINGS

The teaching of the present disclosure can be readily understood by considering the following detailed description in conjunction with the accompanying drawings, in which:

FIG. 1 illustrates an example system of the present disclosure;

FIG. 2 illustrates a diagram of possible scenarios of one embodiment of the present disclosure;

FIG. 3 illustrates an example graphical user interface of the present disclosure;

FIG. 4 illustrates an example flowchart of a method for recommending a selection between a reseller and a multi-sided platform (MSP); and

FIG. 5 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

The present disclosure broadly discloses a method and non-transitory computer-readable medium for recommending a selection between a reseller and a multi-sided platform (MSP). As discussed above, for each newly launched marketplace that serves as an intermediary between buyers and sellers, the newly launched marketplace must decide which business model to adopt to make profits. Typically, the business model is chosen based upon a manual decision. The manual decision may not analyze all of the possible variables that may affect the outcome of profits. The manual decision may also make a decision without having all of the relevant information to guide selection of a business model. Thus, business models are often adopted based upon an inaccurate or inefficient method

One embodiment of the present disclosure provides a method for automatically recommending a selection between a reseller and an MSP. In one embodiment, given the choice of a reseller or an MSP in one of four scenarios that involve a service provider, two intermediaries and a customer, the system of the present disclosure will recommend a user or requestor to select either the reseller or the MSP based on one of the four scenarios. For example, the recommendation may be provided in a graphical user interface (GUI) that displays all of the optimal prices for each one of the four scenarios and the recommended selection in the respective scenario.

In one embodiment, a reseller may be defined as an intermediary that purchases goods at a wholesale price from a service provider or supplier and sells the goods again to a customer at a market price to make profits through margins between the market price and the wholesale price. In one embodiment, the MSP may be defined as a platform that can function to enable direct interactions between the service provider or supplier and customers and make profits through charging listing or transaction fees to either the supplier or the customer or both.

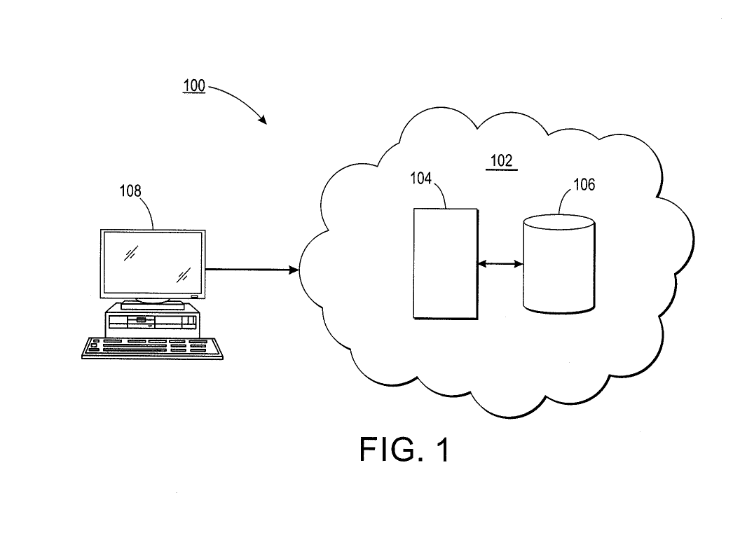

FIG. 1 illustrates an example system 100 of the present disclosure. In one embodiment, the system 100 may include an Internet Protocol (IP) network 102. The IP network 102 may include an application server (AS) 104 and a database (DB) 106. The IP network 102 may include other network elements, such as for example, border elements, firewalls, routers, switches, and the like that are not shown for simplicity. In one embodiment, the IP network 102 may be operated by a service provider for the analysis described herein.

In one embodiment, the AS 104 may perform various functions disclosed herein and be deployed as a server or a general purpose computer described below in FIG. 5. In one embodiment, the DB 106 may store various types of information. For example, the DB 106 may store user information, the algorithms used by the AS 104, the equations discussed below, the results of the analysis performed by the AS 104, and the like.

In one embodiment, the AS 104 may be in communication with one or more endpoint devices 108. In one embodiment, the communication may be over a wired or wireless communication path. Although only one endpoint device 108 is illustrated in FIG. 1, it should be noted that any number of endpoint devices 108 may be deployed.

In one embodiment, the endpoint device 108 may be any type of device having a graphical user interface (GUI) that can be used to submit a request for a recommendation of a selection between a reseller and an MSP in a newly launched marketplace scenario. In one embodiment, the endpoint device 108 may be a desktop computer, a laptop computer, a netbook computer, a tablet computer, a smart phone, and the like.

In one embodiment, the various functions disclosed herein may be deployed directly on to the endpoint device 108 such that the endpoint device 108 does not need to communicate with the AS 104 to obtain the recommendation. For example, the functions described herein can be stored on a computer readable medium and executed by a processor of the endpoint device 108 locally.

In one embodiment, the system 100 may be used to provide a recommendation to a user to select between a reseller and an MSP in a newly launched marketplace that serves between customers and service providers. In one embodiment, the system 100 may analyze automatically all possible variables in determining a maximum pay-off (e.g., a profit, profit margin, and the like) for all possible scenarios that include a plurality of parties.

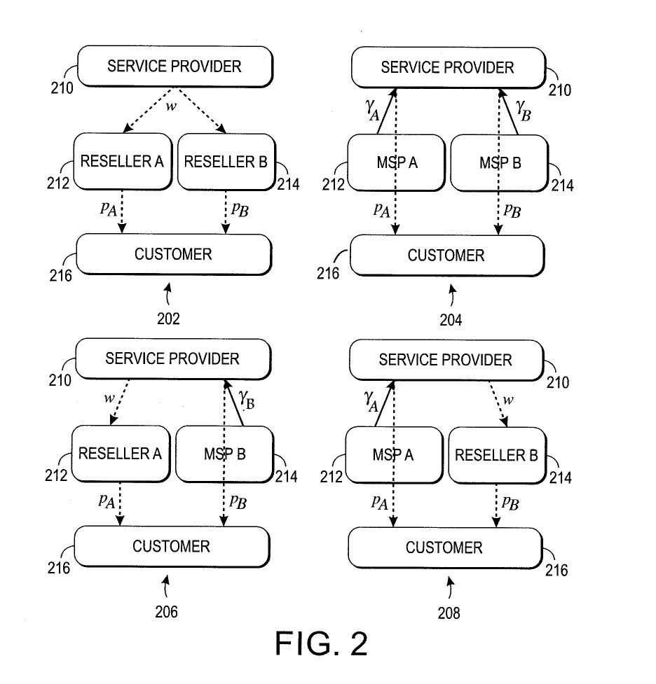

In one embodiment, the plurality of parties may include a service provider, a first intermediary, a second intermediary and a customer. In one embodiment, the first intermediary and the second intermediary may each be either the reseller or the MSP. FIG. 2 illustrates one example of possible scenarios that need to be analyzed to make a recommendation to a user to select between a reseller and an MSP for the given number of parties described above. For example, the scenarios 202, 204, 206 and 208 in FIG. 2 include a service provider 210, a first intermediary party 212, a second intermediary party 214 and a customer 216.

In a first scenario 202, the first intermediary 212 (also referred to as “party A”) and the second intermediary 214 (also referred to as “party B”) are both resellers. In the scenario 202, the parameters may include a wholesale price, w, that may be set by the service provider, a market price, p_{A}, set by the party A 212 and a market price, p_{B}, set by the party B 214.

In the second scenario 204, the party A 212 and the party B 214 are both MSPs. In the scenario 204, the parameters may include a transaction ratio, γ_{A}, for party A's MSP that is set by the party A 212 and transaction ratio, γ_{B}, for party B's MSP that is set by the party B 214. In one embodiment, a transaction ratio may be defined as a percentage the service provider 210 needs to pay the MSP of a party for every one dollar it charges from the customer 216. The second scenario 204 may also include the parameters p_{A} and p_{B} that are each set by the service provider 210.

In the third scenario 206, the party A 212 may be a reseller and the party B may be an MSP. In the scenario 206, the parameters may include w set by the service provider 210 for the party A 212, γ_{B} for the party B's MSP set by the party B 214, p_{A} set by the party A 212 and p_{B} set by the service provider 210.

In the fourth scenario 208, the party A 212 may be an MSP and the party B 214 may be a reseller. In the scenario 208, the parameters may include γ_{A} for party A's MSP set by the party A 212, w set by the service provider 210 for the party B 214, p_{A} set by the service provider 210 and p_{B} set by the party B 214.

In one embodiment, the four scenarios 202, 204, 206 and 208 are analyzed by the system 100 based upon a leader-follower game model. For example, once the service provider 210 sets the wholesale price, w, and chooses to sell exclusively to the party A 212, to the party B, 214 or both the party A 212 and the party B 214, the party A 212 and the party B 214 may set the respective market prices, p_{A} and p_{B}.

In one embodiment, the four scenarios 202, 204, 206 and 208 analyzed by the system 100 are also based upon a Bertrand competition model between the party A 212 and the party B 214. For example, the customer 216 has no preference for any type of marketplace and decides from which party to buy the service or product solely based on a comparison of the market prices. In other words, the intermediary with the lower market price has 100 percent of the demand and the intermediary with the higher market price has zero percent of the demand.

In one embodiment, for a linear demand function p=αQ+β, where α and β are constants, if the service provider 210 decides to sell exclusively to the party A 212, the demand for party A 212, Q_{A}, and the demand for the party B 214, Q_{B}, may be defined as follows:

$${Q}_{A} = \frac{{p}_{A} - β}{α} , {Q}_{B} = 0 ,$$

where α and β are constants. If the service provider 210 decides to sell exclusively to the party B 214, the demand for the party A 212 and the party B 214 may be defined as follows:

$${Q}_{A} = 0 , {Q}_{B} = \frac{{p}_{B} - β}{α} .$$

If the service provider 210 chooses to sell to both the party A 212 and the party B 214 the demand for the party A 212 and the party B 214 may be dependent on the market prices, p_{A} and p_{B}, set by the party A 212 and the party B 214, respectively. For the party A 212 when the service provider 210 chooses to sell to both the party A 212 and the party B 214, the demand Q_{A} may be defined as follows based upon a comparison of the market prices p_{A} and p_{B}:

$${Q}_{A} = \{ \begin{matrix}0 & {p}_{A} > {p}_{B} \\ \frac{p - β}{2 α} & {p}_{A} = {p}_{B} = p \\ \frac{{p}_{A} - β}{α} & {p}_{A} < {p}_{B}\end{matrix} .$$

For the party B 214, when the service provider 210 chooses to sell to both the party A 212 and the party B 214, the demand Q_{B} may be defined as follows based upon a comparison of the market prices p_{A} and p_{B}:

$${Q}_{B} = \{ \begin{matrix}\frac{{p}_{B} - β}{α} & {p}_{A} > {p}_{B} \\ \frac{p - β}{2 α} & {p}_{A} = {p}_{B} = p \\ 0 & {p}_{A} < {p}_{B}\end{matrix} .$$

In one embodiment, the system 100 may also consider additional parameters when analyzing all of the scenarios 202, 204, 206 and 208. For example, the parameters may also include a marginal cost, a fixed cost and a variable. In one embodiment, the marginal cost, c, may represent marginal costs for supplying the service or the product, e.g., power consumption for running an optical character reader service each time.

In one embodiment, the fixed cost may be associated with the reseller and the MSP. In one embodiment, the fixed cost may include the costs for selling the service or product, e.g., a cost for hosting a service on servers. The fixed cost for the reseller may be represented by the function Fᵢ^{R}(i=A, B) and are paid by the reseller party, wherein A and B represent the party A 212 and the party B 214. The fixed cost for the MSP may be represented by the function Fᵢ^{M}(i=A, B) and are paid by the service provider 210.

In one embodiment, the variable cost may be associated with the reseller and the MSP. In one embodiment, the variable cost may include costs for selling the service or product, e.g., a cost for after-sale support on the service or product. The variable cost for the reseller may be represented by the function ƒᵢ^{R} (i=A, B) and are paid by the reseller party, wherein A and B represent the party A 212 and the party B 214. The variable cost for the MSP may be represented by the function ƒᵢ^{M}(i=A, B) and are paid by the service provider 210.

In one embodiment, given all of the parameters described above, the system 100 may then automatically analyze all of the scenarios 202, 204, 206 and 208 and make a recommendation to a user a selection between the reseller and the MSP for a scenario that provides a maximum pay-off. In one embodiment, the pay-off, π, for each one of the plurality of parties may be calculated by the system 100 to make the recommendation. In one embodiment, each one of the scenarios 202, 204, 206 and 208 are analyzed based on whether the service provider 210 decides to sell exclusively to the party A 212, exclusively to the party B 214 or to both the party A 212 and the party B 214.

For the scenario 202, if the service provider 210 decides to sell exclusively to the reseller A 212, the pay-offs for the service provider 210, πₛ, the first intermediary party A 212, π_{A}, the second intermediary party B 214, π_{B} and the customer 216, π_{c}, would be calculated as follows:

πₛ=(w−c)Q_{A}

π_{A}=(p_{A}−w−ƒ_{A}^{R})Q_{A}−F_{A}^{R}

π_{B}=0

π_{c}=ν−p_{A},

where ν is a willingness to pay for the customer and p_{A} is a function of the demand, p_{A}=D(Q_{A}). If the service provider 210 decides to sell exclusively to the reseller B 214, the pay-offs, πₛ, π_{A}, π_{B} and π_{c} would be calculated as follows:

πₛ=(w−c)Q_{B}

π_{A}=0

π_{B}=(p_{B}−w−ƒ_{B}^{R})Q_{B}−F_{B}^{R}

π_{c}=ν−p_{B},

where p_{B} is a function of the demand, p_{B}=D(Q_{B}). If the service provider 210 decides to sell to both the reseller A 212 and the reseller B 214, the pay-offs, πₛ, π_{A}, π_{B} and π_{c} would be calculated as follows:

$${π}_{s} = ( w - c ) Q$$

$${π}_{A} = \{ \begin{matrix}( {p}_{A} - w - {f}_{A}^{R} ) Q - {F}_{A}^{R} & if {p}_{A} < {p}_{B} \\ \frac{( {p}_{A} - w - {f}_{A}^{R} ) Q}{2} - {F}_{A}^{R} & if {p}_{A} = {p}_{B} \\ - {F}_{A}^{R} & if {p}_{A} > {p}_{B}\end{matrix} \\ {π}_{B} = \{ \begin{matrix}( {p}_{B} - w - {f}_{B}^{R} ) Q - {F}_{B}^{R} & if {p}_{B} < {p}_{A} \\ \frac{( {p}_{B} - w - {f}_{B}^{R} ) Q}{2} - {F}_{B}^{R} & if {p}_{B} = {p}_{A} \\ - {F}_{B}^{R} & if {p}_{B} > {p}_{A}\end{matrix} \\ {π}_{c} = v - p ,$$

wherein the price, p, is a function of the market prices and the demand, Q, according to the functions p=min(p_{A}, p_{B}) and p=D(Q).

For the scenario 204, if the service provider 210 decides to sell exclusively to the MSP A 212, the pay-offs, πₛ, π_{A}, π_{B} and π_{c} would be calculated as follows:

πₛ=((1−γ_{A})p_{A}−ƒ_{A}^{M})Q_{A}−F_{A}^{M}

π_{A}=γ_{A}p_{A}Q_{A}

π_{B}=0

π_{c}=ν−p_{A}

If the service provider 210 decides to sell exclusively to the MSP B 214, the pay-offs, πₛ, π_{A}, π_{B} and π_{c} would be calculated as follows:

πₛ=((1−γ_{B})p_{B}−ƒ_{B}^{M})Q_{B}−F_{B}^{M}

π_{A}=0

π_{B}=γ_{B}p_{B}Q_{B}

π_{c}=ν−p_{B}.

If the service provider 210 decides to sell to both the MSP A 212 and the MSP B 214, the pay-offs, πₛ, π_{A}, π_{B} and π_{c} would be calculated as follows:

$${π}_{s} \{ \begin{matrix}( ( 1 - {γ}_{A} ) {p}_{A} - {f}_{A}^{M} ) Q - {F}_{A}^{M} - {F}_{B}^{M} & if {p}_{A} < {p}_{B} \\ \frac{( ( 1 - {γ}_{A} ) {p}_{A} - {f}_{A}^{M} ) Q}{2} + \frac{( ( 1 - {γ}_{B} ) {p}_{B} - {f}_{B}^{M} ) Q}{2} & if {p}_{A} = {p}_{B} \\ ( ( 1 - {γ}_{B} ) {p}_{A} - {f}_{B}^{M} ) Q - {F}_{A}^{M} - {F}_{B}^{M} & if {p}_{A} > {p}_{B}\end{matrix} \\ {π}_{A} = \{ \begin{matrix}{γ}_{A} {p}_{A} Q & if {p}_{A} < {p}_{B} \\ \frac{{γ}_{A} {p}_{A} Q}{2} & if {p}_{A} = {p}_{B} \\ 0 & if {p}_{A} > {p}_{B}\end{matrix} \\ {π}_{B} = \{ \begin{matrix}{γ}_{B} {p}_{B} Q & if {p}_{B} < {p}_{A} \\ \frac{{γ}_{B} {p}_{B} Q}{2} & if {p}_{B} = {p}_{A} \\ 0 & if {p}_{B} > {p}_{A}\end{matrix} \\ {π}_{c} = v - p ,$$

wherein the price, p, is a function of the market prices and the demand, Q, according to the functions p=min(p_{A},p_{B}) and p=D(Q).

For the scenario 206, if the service provider 210 decides to sell exclusively to the reseller A 212, the pay-offs, πₛ, π_{A}, π_{B} and π_{c} would be calculated as follows:

πₛ=(w−c)Q_{A}

π_{A}=(p_{A}−w−ƒ_{A}^{R})Q_{A}−F_{A}^{R}

π_{B}=0

π_{c}=ν−p_{A}.

If the service provider 210 decides to sell exclusively to the MSP B 214, the pay-offs, πₛ, π_{A}, π_{B} and π_{c} would be calculated as follows:

πₛ((1−γ_{B})p_{B}−ƒ_{B}^{M})Q_{B}−F_{B}^{M}

π_{A}=0

π_{B}=γ_{B}p_{B}Q_{B}

π_{c}=ν−p_{B}.

If the service provider 210 decides to sell to both the reseller A 212 and the MSP B 214, the pay-offs, πₛ, π_{A}, π_{B} and π_{c} would be calculated as follows:

$${π}_{s} = \{ \begin{matrix}( w - c ) Q - {F}_{B}^{M} & if {p}_{A} < {p}_{B} \\ \frac{( w - c ) Q}{2} + \frac{( ( 1 - {γ}_{B} ) {p}_{B} - {f}_{B}^{M} ) Q}{2} & if {p}_{A} = {p}_{B} \\ ( ( 1 - {γ}_{B} ) {p}_{B} - {f}_{B}^{M} ) Q - {F}_{B}^{M} & if {p}_{A} > {p}_{B}\end{matrix} \\ {π}_{A} = \{ \begin{matrix}( {p}_{A} - w - {f}_{A}^{R} ) Q - {F}_{A}^{R} & if {p}_{A} < {p}_{B} \\ \frac{( {p}_{A} - w - {f}_{A}^{R} ) Q}{2} - {F}_{A}^{R} & if {p}_{A} = {p}_{B} \\ - {F}_{A}^{R} & if {p}_{A} > {p}_{B}\end{matrix} \\ {π}_{B} = \{ \begin{matrix}{γ}_{B} {p}_{B} Q & if {p}_{B} < {p}_{A} \\ \frac{{γ}_{B} {p}_{B} Q}{2} & if {p}_{B} = {p}_{A} \\ 0 & if {p}_{B} > {p}_{A}\end{matrix} \\ {π}_{c} = v - p ,$$

wherein the price, p, is a function of the market prices and the demand, Q, according to the functions p=min(p_{A}, p_{B}) and p=D(Q).

For the scenario 208, if the service provider 210 decides to sell exclusively to the MSP A 212, the pay-offs, πₛ, π_{A}, π_{B} and π_{c} would be calculated as follows:

πₛ((1−γ_{A})p_{A}−ƒ_{A}^{M})Q_{A}−F_{A}^{M}

π_{A}=γ_{A}p_{A}Q_{A}

π_{B}=0

π_{c}=ν−p_{A}.

If the service provider 210 decides to sell exclusively to the reseller B 214, the pay-offs, πₛ, π_{A}, π_{B} and π_{c} would be calculated as follows:

πₛ=(w−c)Q_{B}

π_{A}=0

π_{B}=(p_{B}−w−ƒ_{B}^{R})Q_{B}−F_{B}^{R}

π_{c}=ν−p_{B}.

If the service provider 210 decides to sell to both the MSP A 212 and the reseller B 214, the pay-offs, πₛ, π_{A}, π_{B} and π_{c} would be calculated as follows:

$${π}_{s} \{ \begin{matrix}( ( 1 - {γ}_{A} ) {p}_{A} - {f}_{A}^{M} ) Q - {F}_{A}^{M} & if {p}_{A} < {p}_{B} \\ \frac{( ( 1 - {γ}_{A} ) {p}_{A} - {f}_{A}^{M} ) Q}{2} + \frac{( w - c ) Q}{2} - {F}_{A}^{M} & if {p}_{A} = {p}_{B} \\ ( w - c ) Q - {F}_{A}^{M} & if {p}_{A} > {p}_{B}\end{matrix} \\ {π}_{A} = \{ \begin{matrix}{γ}_{A} {p}_{A} Q & if {p}_{A} < {p}_{B} \\ \frac{{γ}_{A} {p}_{A} Q}{2} & if {p}_{A} = {p}_{B} \\ 0 & if {p}_{A} > {p}_{B}\end{matrix} \\ {π}_{B} = \{ \begin{matrix}( {p}_{B} - w - {f}_{B}^{R} ) Q - {F}_{B}^{R} & if {p}_{B} < {p}_{A} \\ \frac{( {p}_{B} - w - {f}_{B}^{R} ) Q}{2} - {F}_{B}^{R} & if {p}_{B} = {p}_{A} \\ - {F}_{B}^{R} & if {p}_{B} > {p}_{A}\end{matrix} \\ {π}_{c} = v - p ,$$

wherein the price, p, is a function of the market prices and the demand, Q, according to the functions p=min(p_{A},p_{B}) and p=D(Q).

Using the equations described above for each one of the service provider 210, the party A 212, the party B 214 and the customer 216 for all of the scenarios 202, 204, 206 and 208, the system 100 may analyze and calculate a maximum profit to recommend a user to select to be either a reseller or an MSP for a particular scenario. In one embodiment, equations described above may be analyzed using backward induction to calculate each party's optimal strategy. The optimal strategy may include, for example, a choice of the optimal wholesale price, the optimal market price, the optimal transaction ratio, and a decision on which marketplace to sell the service or product to. The analysis assumes that all of the parties are rational and follow the linear demand function p=αQ+β, described above. For example, in the scenario 206 the order of decision making may be the MSP B 214→the service provider 210→the reseller A 212. The order of analysis in the scenario 206 may then be the reseller A 212→the service provider 210→the MSP B 214.

So the analysis may start from the reseller A 212 when using backward induction. For example, assuming the reseller A 212 has set a market price, p_{A}, then the service provider 210 may give their best response to the decision of the reseller A 212 and set a wholesale price, w, for the reseller A 212, the market price, p_{B}, for the MSP B 214 and which marketplace to sell the service or product to. A pay-off may be calculated for whether the service provider 210 sells exclusively to the reseller A 212, exclusively to the MSP B 214 or to both the reseller A 212 and the MSP B 214. The service provider 210 may choose to sell to whichever results in the maximum pay-off.

Finally, based on the selection of the service provider 210, the transaction ratio, γ_{B}, for the MSP B may be calculated to maximize the pay-off, Its, for the party B 214. The above backward induction is provided on as an example using the scenario 206. The backward induction may be used similarly for all of the remaining scenarios 202, 204 and 208.

In one embodiment, the pay-off for each one of the parties may be calculated as described above for each one of the scenarios 202, 204, 206 and 208. The results may be analyzed further to determine if there is any overlap among each party's preference on pattern pairs. For example, the results may be analyzed to determine if all of the parties prefer the same pattern pair given a specific parameter setting. The results may also be analyzed to determine if there is any equilibrium point for the choice of pattern pairs. In one embodiment, the equilibrium may be a Nash equilibrium. A Nash equilibrium pattern pair may be defined as: X-Y (both X and Y are either reseller or MSP) is a Nash equilibrium if when marketplace A chooses pattern X, both marketplace B and the service provider prefer pattern Y. Similarly, given marketplace B's choice on pattern Y, both marketplace A and the service provider prefer pattern X. The Nash equilibrium pattern pair is the stable point for both marketplaces to choose their corresponding patterns, and the service provider will also prefer not to ask any marketplace to deviate from its current pattern given the other marketplace's choice at the equilibrium.

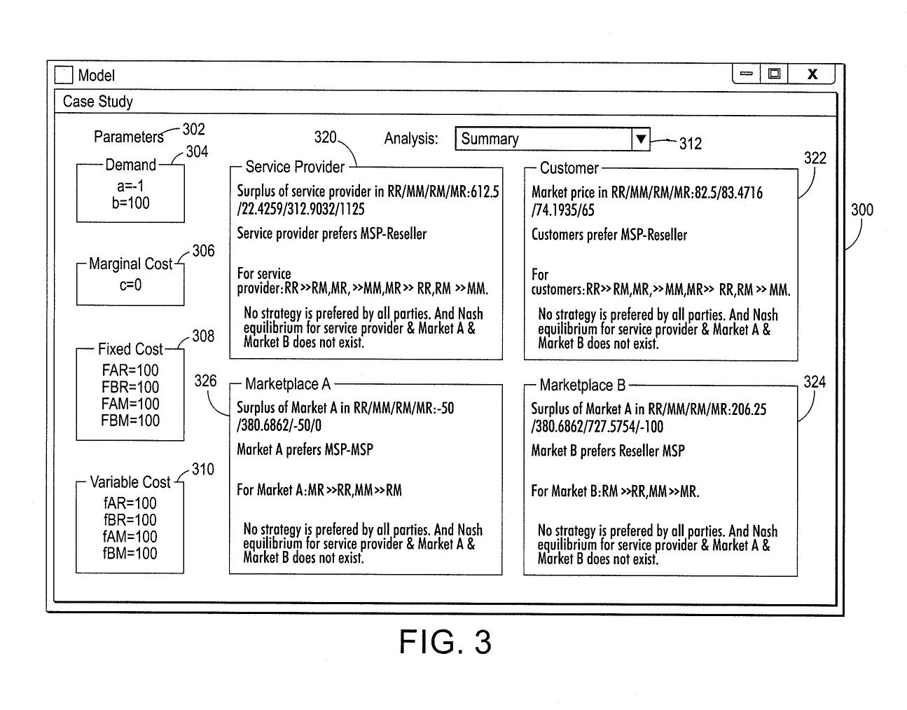

In one embodiment, the results of the calculations and analysis described above may be provided in a graphical user interface (GUI) 300 illustrated in FIG. 3. In one embodiment, the GUI 300 may provide all of the parameters 302 used in the calculations, such as for example, the demand 304, the marginal cost 306, the fixed costs, 308 and the variable costs 310. In one embodiment, the GUI 300 may provide a summary 320, 322, 324 and 326 for each one of the parties and a recommendation on which marketplace model the user should adopt given an analysis of all of the scenarios. For example, each summary 320, 322, 324 and 326 includes a pay-off calculation for each possible scenario 202, 204, 206 and 208. Thus, depending on which party the user is, e.g., either the party A 212 or the party B 214, the GUI 300 may provide a recommendation to the user that the user should select to be either a reseller or an MSP.

In one embodiment, the GUI 300 may also include a drop down menu bar 312 that a user may use to view details for each one of the possible scenarios 202, 204, 206 or 208 described above. The detailed views may include all of the parameters calculated by backward induction described above, such as for example, the wholesale price and the net profit of the service provider 210, the market price, the units sold and the profit for the party A 212, the market price, the units sold and the profit for the party B 214 and the market price for the customer 216.

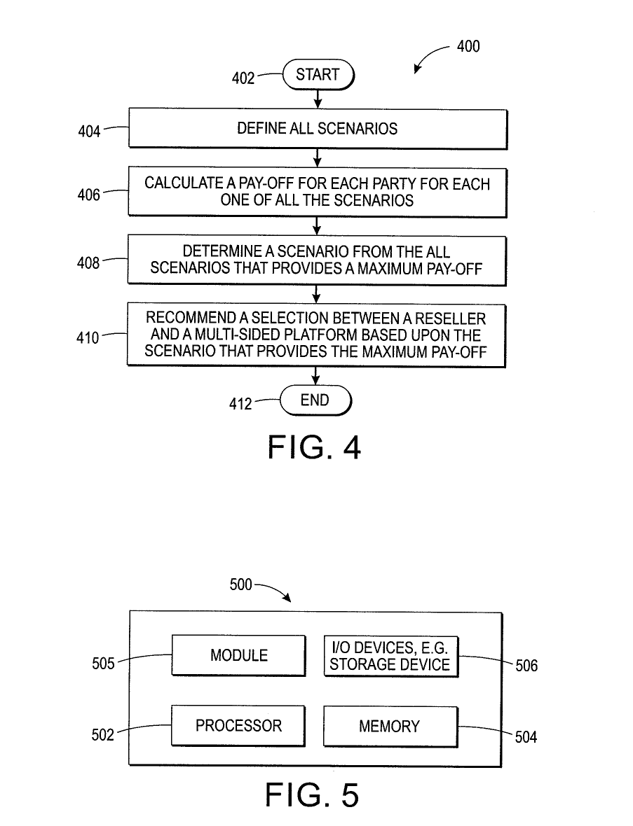

FIG. 4 illustrates a flowchart of a method 400 for recommending a selection between a reseller and an MSP. In one embodiment, one or more steps or operations of the method 400 may be performed by the AS 104 or a general-purpose computer as illustrated in FIG. 5 and discussed below.

At step 402 the method 400 begins. At step 404, the method 400 defines all possible scenarios given a plurality of parties. In one embodiment, the plurality of parties may include a service provider, a first intermediary, a second intermediary and a customer and include four possible scenarios when the first intermediary and the second intermediary may be a reseller or an MSP. All four possible scenarios are illustrated in FIG. 2.

At step 406, the method 400 calculates a pay-off for each party for each one of the scenarios. For example, when the parties include the service provider, the first intermediary, the second intermediary and the customer, a pay-off for the service provider, a pay-off for the first intermediary, a pay-off for the second intermediary and a pay-off for the customer may each be calculated. The pay-off for each party for each one of the scenarios may be calculated using the modeling, equations and assumptions described above for each one of the scenarios 202, 204, 206 and 208 illustrated in FIG. 2.

At step 408, the method 400 determines a scenario from all of the scenarios that provides a maximum pay-off. For example, all of the pay-offs that are calculated for each one of the scenarios may be compared to determine which scenario has the highest pay-off. The highest pay-off may be determined to be the maximum pay-off and the MSP or the reseller

At step 410, the method 400 recommends a selection between a reseller and an MSP based upon the scenario that provides the maximum pay-off. In one embodiment, the recommendation may be provided via a GUI on an endpoint device of a user. At step 412, the method 400 ends.

It should be noted that although not explicitly specified, one or more steps, functions, or operations of the method 400 described above may include a storing, displaying and/or outputting step as required for a particular application. In other words, any data, records, fields, and/or intermediate results discussed in the methods can be stored, displayed, and/or outputted to another device as required for a particular application. Furthermore, steps, functions, or operations in FIG. 4 that recite a determining operation, or involve a decision, do not necessarily require that both branches of the determining operation be practiced. In other words, one of the branches of the determining operation can be deemed as an optional step.

FIG. 5 depicts a high-level block diagram of a general-purpose computer suitable for use in performing the functions described herein. As depicted in FIG. 5, the system 500 comprises a processor element 502 (e.g., a SIMD, a CPU, and the like), a memory 504, e.g., random access memory (RAM) and/or read only memory (ROM), a module 505 for recommending a selection between a reseller and an MSP in an image, and various input/output devices 506 (e.g., storage devices, including but not limited to, a tape drive, a floppy drive, a hard disk drive or a compact disk drive, a receiver, a transmitter, a speaker, a display, a speech synthesizer, an output device (such as a graphic display, printer, and the like), an output port, and a user input device (such as a keyboard, a keypad, a mouse, and the like)).

It should be noted that the present disclosure can be implemented in software and/or in a combination of software and hardware, e.g., using application specific integrated circuits (ASIC), a general purpose computer or any other hardware equivalents, e.g., computer readable instructions pertaining to the method(s) discussed above can be used to configure a hardware processor to perform the steps of the above disclosed methods. In one embodiment, the present module or process 505 for recommending a selection between a reseller and an MSP in an image can be loaded into memory 504 and executed by processor 502 to implement the functions as discussed above. As such, the present method 505 for recommending a selection between a reseller and an MSP in an image (including associated data structures) of the present disclosure can be stored on a non-transitory (e.g., physical and tangible) computer readable storage medium, e.g., RAM memory, magnetic or optical drive or diskette and the like. For example, the hardware processor 502 can be programmed or configured with instructions (e.g., computer readable instructions) to perform the steps, functions, or operations of method 400.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A method for recommending a selection between a reseller and a multi-sided platform (MSP), comprising:
defining, by a processor, all scenarios for a service provider, a first intermediary, a second intermediary and a customer, wherein the first intermediary and the second intermediary are each the reseller or the MSP;
calculating, by the processor, a pay-off for the service provider, the first intermediary, the second intermediary and the customer for each one of the all scenarios;
determining, by the processor, a scenario from the all scenarios that provides a maximum pay-off; and
recommending, by the processor, the selection between the reseller and the MSP based upon the scenario that provides the maximum pay-off.

2. The method of claim 1, wherein the all scenarios comprises the first intermediary as the MSP and the second intermediary as the reseller, the first intermediary as the MSP and the second intermediary as the MSP, the first intermediary as the reseller and the second intermediary as the MSP and the first intermediary as the reseller and the second intermediary as the reseller.

3. The method of claim 1, wherein the calculating is based upon a Bertrand competition between the first intermediary and the second intermediary using a linear demand function.

4. The method of claim 1, wherein each one of the all scenarios further comprises when the service provider sells exclusively to the first intermediary, when the service provider sells exclusively to the second intermediary and when the service provider sells to both the first intermediary and the second intermediary.

5. The method of claim 1, wherein the calculating is performed based upon one or more functions using one or more of a plurality of parameters, the plurality of parameters comprising at least two of: a cost for supplying a service, a fixed cost, a variable cost, a demand, a market price of the first intermediary, a market price of the second intermediary, a transaction ratio and a price to pay to obtain the customer.

6. The method of claim 5, wherein the transaction ratio is for the MSP and represents a percentage the service provider needs to pay the MSP for every dollar the service provider charges the customer.

7. The method of claim 1, wherein the determining further comprises using backward induction to calculate an optimal wholesale price, an optimal market price and an optimal transaction ratio.

8. The method of claim 1, wherein the recommending is provided by a graphical user interface (GUI) on an endpoint of a requestor.

9. The method of claim 8, wherein the pay-off for the service provider, the first intermediary, the second intermediary and the customer are provided via the GUI.

10. A non-transitory computer-readable medium storing a plurality of instructions which, when executed by a processor, cause the processor to perform operations for recommending a selection between a reseller and a multi-sided platform (MSP), the operations comprising:
defining all scenarios for a service provider, a first intermediary, a second intermediary and a customer, wherein the first intermediary and the second intermediary are each the reseller or the MSP;
calculating a pay-off for the service provider, the first intermediary, the second intermediary and the customer for each one of the all scenarios;
determining a scenario from the all scenarios that provides a maximum pay-off; and
recommending the selection between the reseller and the MSP based upon the scenario that provides the maximum pay-off.

11. The non-transitory computer-readable medium of claim 10, wherein the all scenarios comprises the first intermediary as the MSP and the second intermediary as the reseller, the first intermediary as the MSP and the second intermediary as the MSP, the first intermediary as the reseller and the second intermediary as the MSP and the first intermediary as the reseller and the second intermediary as the reseller.

12. The non-transitory computer-readable medium of claim 10, wherein the calculating is based upon a Bertrand competition between the first intermediary and the second intermediary using a linear demand function.

13. The non-transitory computer-readable medium of claim 10, wherein each one of the all scenarios further comprises when the service provider sells exclusively to the first intermediary, when the service provider sells exclusively to the second intermediary and when the service provider sells to both the first intermediary and the second intermediary.

14. The non-transitory computer-readable medium of claim 10, wherein the calculating is performed based upon one or more functions using one or more of a plurality of parameters, the plurality of parameters comprising at least two of: a cost for supplying a service, a fixed cost, a variable cost, a demand, a market price of the first intermediary, a market price of the second intermediary, a transaction ratio and a price to pay to obtain the customer.

15. The non-transitory computer-readable medium of claim 14, wherein the transaction ratio is for the MSP and represents a percentage the service provider needs to pay the MSP for every dollar the service provider charges the customer.

16. The non-transitory computer-readable medium of claim 10, wherein the determining further comprises using backward induction to calculate an optimal wholesale price, an optimal market price and an optimal transaction ratio.

17. The non-transitory computer-readable medium of claim 10, wherein the recommending is provided by a graphical user interface on an endpoint of a requestor.

18. The non-transitory computer-readable medium of claim 10, wherein the pay-off for the service provider, the first intermediary, the second intermediary and the customer are provided via the GUI.

19. A method for recommending a selection between a reseller and a multi-sided platform (MSP), comprising:
defining, by a processor, a first scenario comprising a service provider, a first intermediary as the reseller, a second intermediary as the MSP and a customer, a second scenario comprising the service provider, the first intermediary the reseller, the second intermediary as the reseller and the customer, a third scenario comprising the service provider, the first intermediary as the MSP, the second intermediary as the reseller and the customer and a fourth scenario comprising, the service provider, the first intermediary as the MSP, the second intermediary as the MSP and the customer;
calculating, by the processor, a pay-off for the service provider, the first intermediary, the second intermediary and the customer based upon when the service provider sells exclusively to the first intermediary, when the service provider sells exclusively to the second intermediary and when the service provider sell to the first intermediary and the second intermediary for the first scenario, the second scenario, the third scenario and the fourth scenario, wherein the pay-off is based on a Bertrand competition that assumes an intermediary with a higher price has a demand of zero per cent, an intermediary with a lower price has the demand of 100 per cent and a price of the first intermediary and the second intermediary are equal, the demand is equal for the first intermediary and the second intermediary;
determining, by the processor, a scenario from the first scenario, the second scenario, the third scenario and the fourth scenario that provides a maximum pay-off; and
recommending, by the processor, the selection between the reseller and the MSP based upon the scenario that provides the maximum pay-off via a graphical user interface on an endpoint of a requestor.

20. The method of claim 18, wherein the calculating is performed based upon one or more functions using one or more of a plurality of parameters, the plurality of parameters comprising at least two of: a cost for supplying a service, a fixed cost, a variable cost, a demand, a market price of the first intermediary, a market price of the second intermediary, a transaction ratio and a price to pay to obtain the customer.
